(19) United States
(12) Patent Application Publication
(10) Pub. No.: US 2010/0083171 A1
(43) Pub. Date: Apr. 1, 2010

(54) AUTOMATICALLY GENERATING USER INTERFACES IN A TRADING PARTNER COLLABORATION MANAGEMENT ENVIRONMENT

(75) Inventors: CHRISTOPHE BEGUE, San Francisco, CA (US); Keeranoor Kumar, Randolph, NJ (US); Mark H. Linehan, Yorktown Heights, NY (US); Prabir Nandi, Duluth, GA (US); Vishwanath Narayan, Boca Raton, FL (US)

Correspondence Address: FLEIT GIBBONS GUTMAN BONGINI & BIANCO P.L., 551 NW 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 12/242,068

(22) Filed: Sep. 30, 2008

(51) Int. Cl. G06F 3/048; G06F 7/06; G06F 17/30

(52) U.S. Cl. 715/810; 707/E17.014

(57) ABSTRACT

Systems and methods are provided for automatically generating user interfaces in a trading partner collaboration environment. At least one trading partner business rule that defines at least one trading partner agreement between at least two trading partners is retrieved. A user interface based on the at least one trading partner business rule and the at least one trading partner agreement is automatically generated. The user interface enables a user to respond to an outbound message and/or create an inbound message. A set of inbound messages available for creation is displayed, via the user interface, to the user. The set of inbound messages that are displayed are based on the at least one trading partner business rule and the at least one trading partner agreement.

### CROSS-REFERENCE TO RELATED APPLICATIONS

This application is related to application “Automatic Determination of Selective Message Caching To Support Rules in a Trading Partner Collaboration Management Environment,” Ser. No. ______, Attorney Docket No. YOR920080539US1, now ______, and application “Generation of Formal Specifications of Trading Partner Agreements,” Ser. No. ______, Attorney Docket No. YOR920080541US1, now ______, which were filed on the same day as the present application and commonly assigned therewith to International Business Machines Corporation. These related applications are incorporated herein by reference in their entirety.

### FIELD OF THE INVENTION

The present invention generally relates to the field of trading partner collaboration management, and more particularly relates to the automatic generation of user interfaces in a trading partner collaboration management environment.

### BACKGROUND OF THE INVENTION

The Internet has allowed companies to exploit electronic communications to engage in as Business-to-Business (B2B) transactions with other companies. B2B transactions involve conducting business such as buying and selling goods and services over the Internet with trading or business partners. Trading partners are businesses that exchange goods or services for value. For example, trading partners can be a manufacturer and a raw goods supplier that supplies the manufacturer.

In B2B environments trading partners usually have trading agreements established with each other. Trading partner agreements generally cover a wide range of issues which include the enforcement of contracts, protocols, and service level agreements (SLAs) on B2B transactions. A business typically utilizes one or more trading partner management systems for managing B2B transactions with its trading partners. These systems are generally directed to defining, configuring, executing, and monitoring the business's B2B transactions and adherence of those transactions to trading partner agreements.

However, in many instances trading partners have implemented disparate systems to diversify the number of available B2B channels for B2B transactions. Because these disparate systems are deployed among trading partners, trading partner collaboration management is difficult with conventional trading partner management systems. Also, conventional trading partner management systems generally do not provide a convenient and efficient way to establish trading agreements and B2B processes with trading partners with differing supply chain models.

Another problem with these conventional trading partner management systems is that they usually do not provide support for common collaboration processes and business rules in the context of heterogeneity of B2B connectivity protocols and standards. Another drawback of conventional trading partner management systems is that B2B integrations with small and medium sized business partners that have extremely limited B2B capabilities and IT budgets are difficult to establish. Further, conventional trading partner management systems generally do not provide an improvement in the quality of B2B data in the face of many manual processes for message creation and the need for conformance to several business rules and trading partner agreements.

### SUMMARY OF THE INVENTION

One embodiment of the present invention provides a method for automatically generating user interfaces in a trading partner collaboration environment. According to the method, at least one trading partner business rule that defines at least one trading partner agreement between at least two trading partners is retrieved. A user interface is automatically generated based on the at least one trading partner business rule and the at least one trading partner agreement. The user interface enables a user to respond to an outbound message and/or create an inbound message. A set of inbound messages available for creation is displayed, via the user interface, to the user. The set of inbound messages that are displayed are based on the at least one trading partner business rule and the at least one trading partner agreement.

Another embodiment of the present invention provides an information processing system that automatically generates user interfaces in a trading partner collaboration environment. The information processing system includes a memory and a processor that is communicatively coupled to the memory. A trading partner collaboration manager is communicatively coupled to memory and the processor. The trading partner collaboration manager is adapted to retrieve at least one trading partner business rule that defines at least one trading partner agreement between at least two trading partners is retrieved. A user interface is automatically generated based on the at least one trading partner business rule and the at least one trading partner agreement. The user interface enables a user to respond to an outbound message and/or create an inbound message. A set of inbound messages available for creation is displayed, via the user interface, to the user. The set of inbound messages that are displayed are based on the at least one trading partner business rule and the at least one trading partner agreement.

A further embodiment of the present invention provides a computer program product for automatically generating user interfaces in a trading partner collaboration environment. The computer program product includes instructions for retrieving at least one trading partner business rule that defines at least one trading partner agreement between at least two trading partners is retrieved. A user interface is automatically generated based on the at least one trading partner business rule and the at least one trading partner agreement. The user interface enables a user to respond to an outbound message and/or create an inbound message. A set of inbound messages available for creation is displayed, via the user interface, to the user. The set of inbound messages that are displayed are based on the at least one trading partner business rule and the at least one trading partner agreement.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

FIG. 1 is a block diagram illustrating an operating environment in accordance with one embodiment of the present invention;

FIG. 2 is a block diagram illustrating a detailed view of an enterprise information processing system according to one embodiment of the present invention;

FIG. 3 is a block diagram illustrating another view of an enterprise information processing system according to one embodiment of the present invention;

FIG. 4 is a logical view of a data model according to one embodiment of the present invention;

FIG. 5 is a flow diagram illustrating a process for automatically generating user interfaces to generate B2B messages that are compliant with business rules according to one embodiment of the present invention;

FIG. 6 is a block diagram illustrating an information processing system that is useful for implementing embodiments of the present invention;

FIG. 7 is a hierarchical view of functional layers and modules of a trading partner collaboration management environment according to one embodiment of the present invention.

### DETAILED DESCRIPTION

Exemplary embodiments of the present invention will be described in detail hereinbelow with reference to the attached drawings.

Embodiments of the present invention automatically generate user interfaces to generate Business-to-Business (B2B) messages that are compliant with business rules. These user interfaces enforce the creation of messages which observe the business rules at all layers (e.g., the transactional layer, the collaboration layer, and the message exchange layer). Further, these user interfaces also support a partially ordered set of queries against the cached prior transaction information in order to determine which cached message element values may be reused. The partial ordering ensures that the conceptual information hierarchy is reflected within supply chain messages. These user interfaces can also be generated with a few simple steps once collaboration patterns and business rules are laid down.

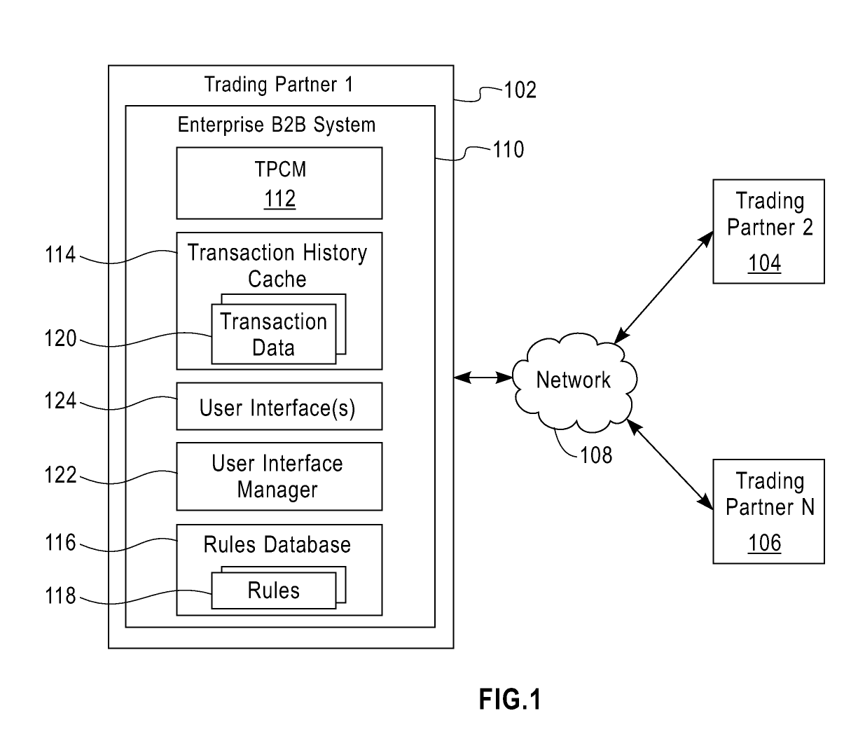

FIG. 1 is a block diagram illustrating an operating environment according to one embodiment of the present invention. The operating environment 100 includes a number of trading partners 102, 104, and 106 that are communicatively coupled to each other via one or more networks 108. Trading partners are businesses that exchange goods and/or services for value. Each trading partner 102, 104, and 106 utilizes one or more information processing systems, such as an enterprise system 110, for performing, among other things, B2B transactions.

In this embodiment, the exemplary enterprise system 110 includes a trading partner collaboration manager (TPCM) 112. The TPCM 112 manages the organization and coordination of trading partner activities between a given trading partner 102 implementing the TPCM 112 and the other trading partners 104 and 106. For example, the TPCM 112 manages activities such as (but not limited to) negotiations (e.g., establishing terms and conditions for collaboration such as business parameters including price, quantity, and delivery date), orders (and order changes or cancellations), shipment notifications, invoicing and payments, and exception handling (such as errors, damaged goods, and delays).

The TPCM 112 further manages trading partner processes, business rules, message exchange and integration, and partner collaboration solutions. Trading partner process management includes supporting stateful conversational exchange of information between trading partners and enabling dynamic negotiations to determine mutually acceptable values of business parameters. Business rule management includes enforcing trading partner agreements by governing the admissibility of message transmission, intended negotiation step, and message business content in a context dependent way. Business rule management also includes enabling conditions that govern message routing, or events for measuring key performance indicators (KPIs). Message and exchange integration management includes supporting automated and user-interaction-centric mechanisms to exchange B2B messages and supporting integration of B2B public processes and business rules with enterprise private processes and edge applications. Message and exchange integration management also includes performing data transformations necessary to address variability of B2B and backend data formats. Partner collaboration solution management includes monitoring of the B2B processes and message flows for tracking KPIs and exceptional behavior.

The TPCM 112 also maintains and manages a transaction information history cache 114. The transaction history cache 114 includes information 120 that is mutually shared by the trading partners 102, 104, and 106 and that is used in the execution of business rules 118 related to new transactions. B2B transactions generally take the form of B2B messages. B2B messages can be in a variety of standard or proprietary formats such as (but not limited to) Rosettanet, EDI X12, XBRML, and ACORD. The messages can be inbound (from a trading partner) or outbound (to a trading partner). Messages can originate from or be processed by either automated software or by portals that display messages as forms for interpretation or manually input by human beings.

The TPCM 112 enforces trading partner agreements by governing the admissibility of message transmission, intended negotiation steps, and message business content in a context dependent way utilizing the transaction history cache 114 and business rules 118. The TPCM 112 also includes one or more databases 116 that include the business rules 118 associated with each trading partner 104 and 106 of the business 102 implementing the TPCM 112. The business rules 118 enable validations across multiple B2B messages/transactions between the trading partners 102, 104, and 106 and can be based on trading partner collaboration agreements. The TPCM 112 also includes a user interface manager 122 and user interfaces 124. The user interface manager 122 automatically generates the user interfaces 124 for creating B2B messages that are compliant with the business rules 118.

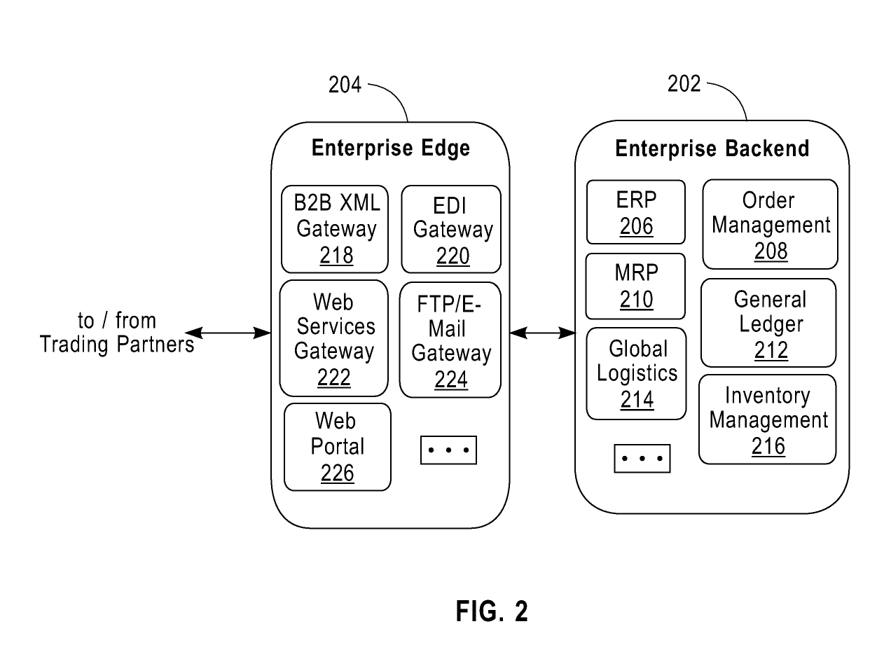

FIG. 2 is a block diagram illustrating a more detailed view of the enterprise system of FIG. 1. As shown, the enterprise system 110 includes an enterprise backend 202 and an enterprise edge 204. The enterprise backend 202 includes various systems that perform associated business operations. For example, the enterprise backend 202 of this exemplary embodiment includes an Enterprise Resource Planning (ERP) system 206, an order management system 208, a Materials Requirement Planning (MRP) system 210, a general ledger system 212, a global logistics system 214, and an inventory management system 216. In further embodiments, the enterprise backend can include different systems.

The enterprise edge 204 includes various gateway applications 218-226 that interface with the other trading partners 104 and 106. The gateway applications 218-226 can either be fully automated (e.g., B2B XML, EDI (Electronic Data Interchange), or Web services) or partially automated (Web Portal or FTP/Email). In further embodiments, the enterprise edge can include different applications from those shown in FIG. 2. The enterprise edge gateways 218-226 of this embodiment provide the following functions: message format conversion (such as XML-based Trading Partner messages to/from SAP or other enterprise backend software), message routing (such as routing a purchase order (PO) message to a Backend System or routing advanced shipping notices (ASNs) to a Backend System), low-level message content validation (such as requiring that an ID field must not be empty or that the total number of line items must be between 1 and 10), and human interfacing (portal) for use by trading partners that do not support electronic trading (with the portal converting between electronic messages and “forms” (e.g., XForms) on the screen).

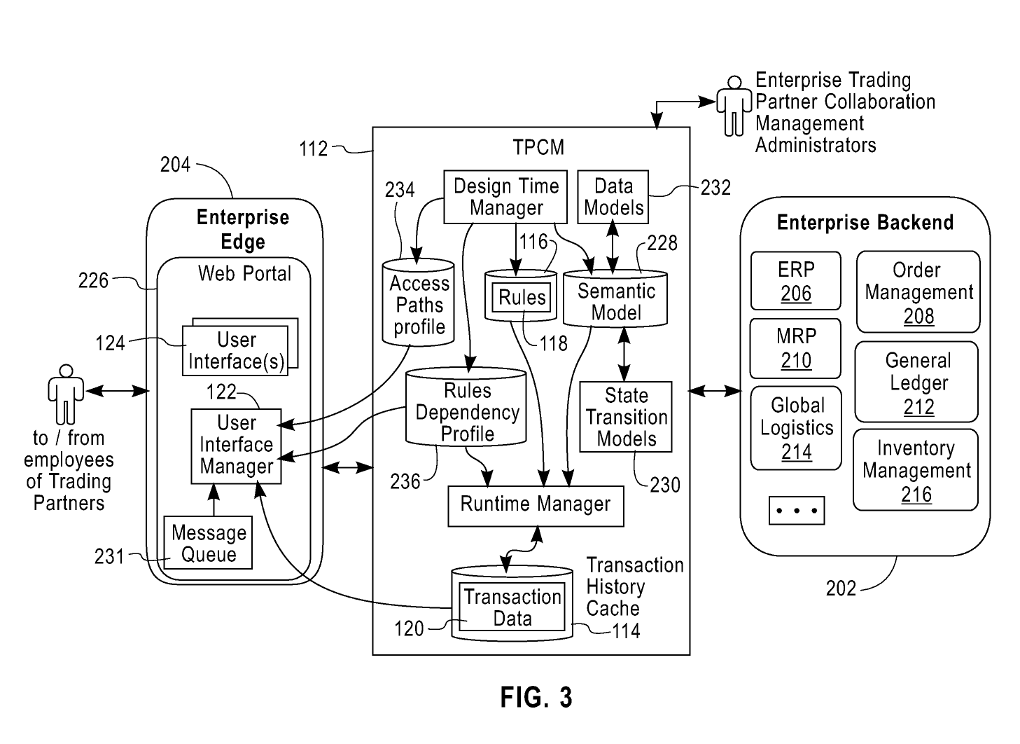

In many instances, a trading partner does not have automated trading systems. In such cases, the enterprise edge 204 may only include a web portal 226, as shown in FIG. 3. The web portal 226 acts as an enterprise edge gateway when a trading partner does not have automated trading systems. The web portal 226 permits employees of the trading partner to enter inbound messages that are sent to the enterprise system 110 and to process outbound messages that are sent from the enterprise system 110. The web portal 226 also translates between the trading message electronic formats and human readable user interfaces. Typically, these user interfaces solicit message inbound data or present message outbound data in electronic versions of paper forms.

While trading partners exchange a large number of messages that include a larger number of message fields, many of these messages and message fields are only relevant when referenced in specific trading partner agreements. That is, different messages and message fields are needed for different trading partners. For example, a consumption message is only needed when a supplier maintains a supply stock at the consumer, and a “Reason Code” field of an “Inbound POLI Change Response-Counter” message is only needed when there is an explicit trading partner agreement that requires one of the predefined reason codes to be used.

Presenting all of messages and message fields in a web portal is inefficient and impractical. Manually configuring which messages and message fields to present to which trading partners is also inefficient and error prone. A trading partner with limited information technology (IT) infrastructure is not able to create, connect, and send the correct messages into the IT stream of their trading partners. In this situation it is not uncommon for the trading partner with limited IT to expect their trading partners to provide an easy way to generate the appropriate messages.

Further, the trading partner that has the required level of IT infrastructure usually cannot scale by creating these messages manually each time one of the underlying constructs change (e.g., rules and/or message definitions), or a when a new constraint is introduced. This can be seen as a versioning problem. Also, it is usually not desirable to solicit information from trading partners when the same information has been entered in a previous message/form. Additionally, incorrect, invalid, and/or inconsistent messages can raise unnecessary exception conditions in the business flow of the trading partners, thus requiring unnecessary and costly infrastructure to be implemented to handle the exception conditions. This constraint requires a “prevention” approach over a “cure”. Preferably, the types of messages that can be generated by a person using a web portal depend on the authorization credentials of the person. For example, a small scale trading partner may not have access to access profiles and other necessary infrastructure.

Therefore, in the embodiment of the present invention shown in FIG. 3, the TPCM 112 is situated between the enterprise edge 204 and the enterprise backend 202. The TPCM automatically generates user interfaces to generate B2B messages that are compliant with the business rules 118 and the three cooperating layers of state machines (i.e., the transactional layer, the collaboration layer, and the message exchange layer). The TPCM 112 also manages B2B transactions and ensures that the transactions adhere to established trading partner agreements, as discussed in the related application “Automatic Determination of Selective Message Caching To Support Rules in a Trading Partner Collaboration Management Environment”.

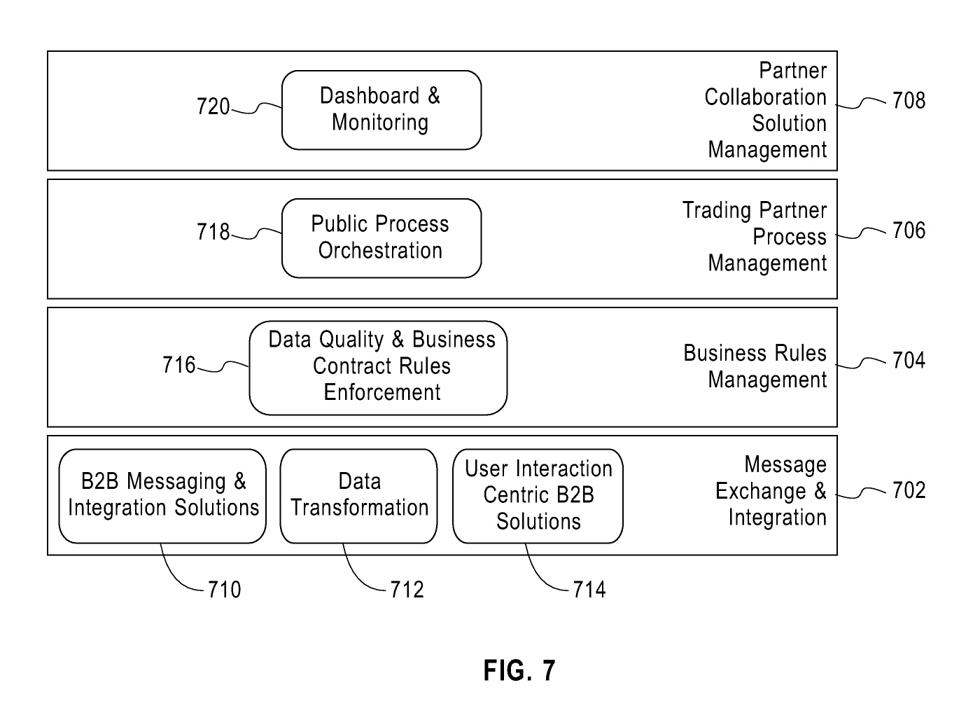

FIG. 7 shows a hierarchical view of the various cooperating/functional layers of a trading partner collaboration management environment according to one embodiment of the present invention. In particular, FIG. 7 shows a Message Exchange and Integration layer 702 at the lowest layer, then moving upwards there is a Business Rules Management layer 704, a Trading Partner Process Management layer 706, and a Partner Collaboration Solution Management layer 708. The Message Exchange and Integration layer 702 carries three application and partner integration functionality related modules. The first is the B2B Messaging and Integration Solutions module 710 that offers the capabilities for machine-to-machine B2B messaging with support for standard formats and protocols such as Electronic Data Interchange (EDI) over Applicability Statement 2 (AS2), RosettaNet over RosettaNet Implementation Framework (RNIF), etc. This module also offers integration with backend applications and edge applications over Java Message Service (JMS), Message Queue (MQ), Web services, etc.

The second module 712 is the User Interaction Centric B2B Solutions module that offers capabilities for manual message inspection and construction with built-in support for ensuring conformance with message validity and business rules. The third module 714 is the Data Transformation module that offers the support for transforming backend and partner facing data formats to the canonical format of the framework and also includes data aggregation and de-aggregation support.

The Business Rules Management layer 704 carries a Data Quality and Business Contract Rules Enforcement module 716 that supports the rules at runtime to detect data inaccuracy and business exceptions and to generate triggers for special actions, complex event management, and KPI measurement. The Trading Partner Process Management layer 706 (e.g., transactional layer) carries Public Process Orchestration modules 718 that support the runtime state machine with associated actions underlying all the TPCM activities involving message delivery, exception handling, and solution management functions. The Partner Collaboration Solution Management layer 708 (e.g., collaboration layer) carries a Dashboard and Monitoring module 720 that supports solution management involving the displays of key business status and system KPIs, and capabilities for exception management.

By disposing the TPCM 112 between the enterprise edge 204 and the enterprise backend 202, partner collaboration processes and rules can operate orthogonal to information exchange models by utilizing a semantic model 228. The semantic model 228 comprises canonical supply chain state transition models 230 and underlying data models 232. The triggering of the state transition models 230 results in changes to B2B transactional content and states expressed in the underlying data model 232.

The semantic model 228, in this embodiment, includes three co-operating layers of state transition models 230 and data models 232 that support them. For example, a transactional layer is supported by a transactional data model cache, a collaboration layer is supported by a collaboration data model cache, and a message exchange layer is supported by a message exchange data model cache. Some aspects of the semantic model 228 can be predefined such as the transactional, collaborative, and message exchange layers, and other aspects can be specified by administrators through the TPCM 112 (such as a specific data model and specific business rules for a particular trading partner).

The data model 232 captures essential supply chain B2B transactional content and state information. For example, a data model 232 can include field names and semantic meanings at each of the message exchange, collaboration, and transaction layers. The data model content is equivalent to vocabularies in the Semantics of Business Vocabularies and Business Rules (SBVR) standard or ontologies in Web Ontology Language (OWL).

Reference schemes can be included in a data model 232 to uniquely identify (i.e., by specifying primary lookup keys) messages and message contents. A data model 232 can also include static information such as trading partner identifiers and web addresses. State information such as “PO received and not responded to” can also be included in a data model 232.

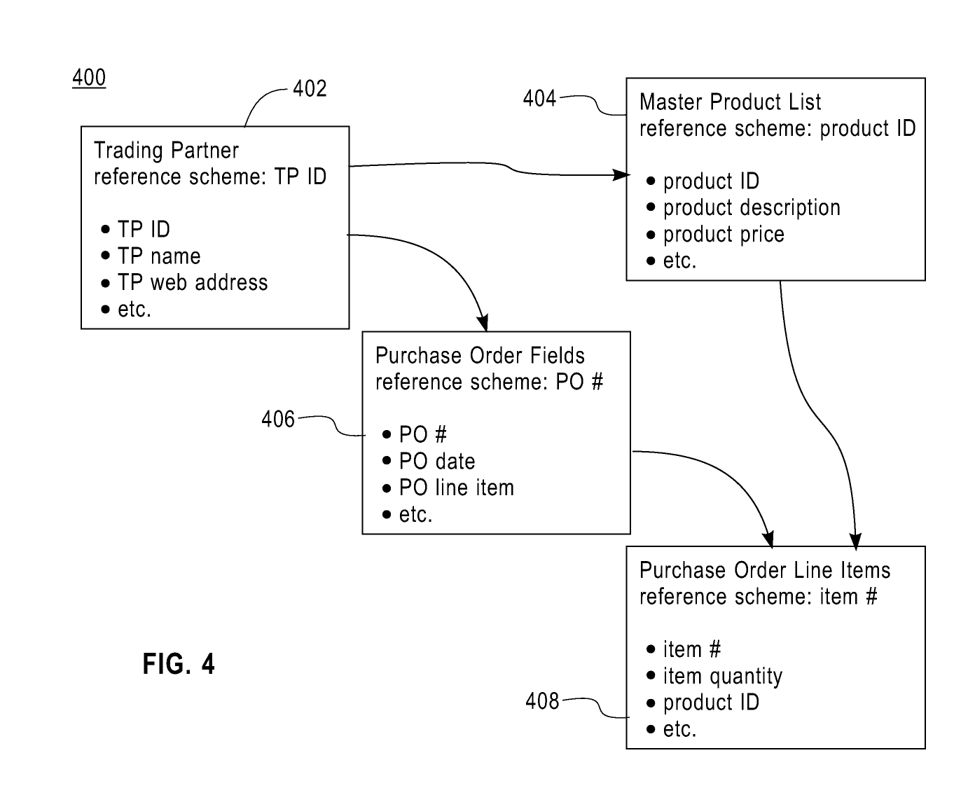

FIG. 4 shows an exemplary data model according to one embodiment of the present invention. The data model 400 comprises a Trading Partner 402 with reference scheme “TP ID”, a Master Product List 404 with reference scheme “product ID”, a Purchase Order Fields 406 with reference scheme “PO #”, and Purchase Order Line Items 408 with reference scheme “item #”. Each reference scheme includes one or more individual attributes. FIG. 4 also shows access paths (indicated by lines connecting reference schemes), which are indexed by a target message field that indicate a sequential order that is to be taken by the TPCM 112 to reach a particular data model element. For example, to access PO line items 408, the TPCM is required to take one of the following access paths: Trading Partner→Purchase Order→PO Line Items, or Trading Partner→Master Product List→PO Line Items. These access paths are stored in the access path profile 234 of the TPCM 112. The TPCM 112 automatically generates the access paths by analyzing the structure of the data model 232.

As discussed above, the TPCM 112 maintains a transaction information history cache 114. The cached transaction history data 120 in the transaction history cache 114 is processed in conjunction with the rules 118 in the rules database 116 to provide more efficient and robust trading partner collaboration management and trading partner agreement adherence monitoring. An exemplary process for maintaining the transaction history cache is discussed in the related application “Automatic Determination of Selective Message Caching To Support Rules in a Trading Partner Collaboration Management Environment”.

The user interface generator 122 of the web portal 226 communicates with the TPCM 112 and its components to automatically generate, starting from business rules 118, the building blocks for message construction wizards (i.e., user interfaces 124) that produce messages at the web portal that are compliant with the rules 118. When the rules 118 are applied in a message construction context, the rules 118 are used to determine what messages are permissible in the current system state and what content is permissible within a message. The rules 118 enable validations across multiple messages and can be based on trading partner collaboration agreements. Trading partner collaboration agreements cover a wide range of issues, which include the enforcement of contracts, protocols, and service level agreements on trading partner B2B messages. Contracts are legal agreements between the businesses that include financial and business terms and conditions concerning the operation aspects of the trade. Examples of contracts are: “when an order is split by a seller at least 50% of quantity must have the original delivery date”, and “seller cannot quote different ‘price’ for the same item when the order is split”.

Protocols include information exchange permissibility and sequencing/timing rules. Examples of protocols are: “seller can only counter a change request by the buyer”, and “when buyer makes changes to ‘quantity’ the seller is allowed to make changes to the delivery date”. Service level agreements (SLAs) include performance and quality of service related rules that pertain to responsiveness, timeliness, and effectiveness. An example of a performance SLA is “at least 80% of the orders which are within forecast limits must be shipped on time”. An example of a quantity SLA is “Account #, Item #, and Currency code, must belong to registered value for this partner and there must not be more than 6 violations in a 6 month period”.

Rules 118 simplify technical requirements on the enterprise backend applications 206-216 and on trading partners 102, 104, and 106. Rules 118 are also configurable to deal with unique requirements of different trading partners. In this embodiment, rules 118 can be defined as conditional or unconditional expressions based on vocabularies (which are part of the semantic model 228). For example, a rule 118 can refer to “the identifier of the PO” where “identifier” and “PO” and the relationship between the two come from the vocabulary. The vocabularies can be based on the SBVR standard and are business descriptions of the message contents as specified in the semantic model 228. For example, vocabularies can include field names and their semantic meanings. In this embodiment, vocabularies are equivalent to ontologies and can have reference schemes that uniquely identify (i.e., by specifying primary lookup keys) messages and message contents.

In this embodiment, a set of rules 118 is defined for each trading partner 102, 104, and 106 at each of the three layers of the semantic model 228 (i.e., the transactional layer, the collaboration layer, and the message exchange layer). The rules 118 determine the processing at each of these layers and can change over time. Rules 118 also constrain (guard) the transitions in the semantic model state transition models. For example, a rule 118 can indicate that a “PO Change” transition is not permitted if a new delivery date resulting from the “PO Change” is greater than 7 days after the existing delivery date. Thus, the state is constrained (i.e., not changed) if the condition that the new delivery date is not greater than 7 days from the existing delivery date is violated. Rules can also specify derivations such as a total cost calculated as the sum of the costs of the line items. One example of a message exchange rule used in the message exchange layer is “each invoice message must reference a corresponding Consumption Notice, and the total invoice quantity must be less than or equal to the total consumption quantity”. Administrators can create, change, and delete rules through the TPCM 112. The creation of rules and the analysis of rules to determine messages, fields, and/or Computed Domain Parameters on which a rule depends are discussed in further detail in the related application.

The user interfaces 124 enforce the creation of messages which observe the state transition rules at all layers (i.e., the transactional layer, the collaboration layer, and the message exchange layer). Further, these user interfaces 124 also support a partially ordered set of queries against the cached prior transaction information 120 in order to determine which cached message element values may be reused. The partial ordering ensures that the conceptual information hierarchy is reflected within supply chain messages. These user interfaces 124 can be generated with a few simple steps once collaboration patterns and business rules 118 are laid down.

A user interface 124 is generated when a particular trading partner does not have automated support for a particular trading message. The automatically generated user interface 124 displays outbound messages received from the enterprise system 110 in an electronic form format. The user interface 124 also solicits inbound messages (via electronic forms) from a user to be sent to the enterprise system 110. The required inbound message content depends upon the particular rules 118 that apply to the combination of an inbound message, the particular trading partner, and any previously-cached information 120. In this embodiment, the user interface 124 selectively solicits information for inbound information and does not solicit information that was provided in a previous message. Therefore, the user interface 122 manager utilizes the dependency profile to determine what message fields are to be solicited from a trading partner. The user interface manager 122 also uses the transaction history cache 114 to avoid soliciting information that has already been provided in a previous message. In this embodiment, the user interface manager 122 follows are partial ordering of data dependencies such as the access paths discussed above (e.g., lookup TP, then PO, then PO line items.)

A detailed description of an illustrative example of automatic user interface generation will now be given. An employee of a trading partner that does not have automated system support accesses the web portal 226. The user interface manager 122 displays a list (queue) of outbound messages that are awaiting attention. In this exemplary embodiment, the user interface generation manager maintains a list (queue) 231 of pending messages for each trading partner. The trading partner employee can see the list 231 as a whole or view specific message details.

The user interface manager 122 also displays a list of new messages that can be initiated. In order to display the list of new messages the user interface manager 122 determines from the state transition models 230 which new inbound messages can be initiated from scratch. The user interface manager 122 then displays options to the employee to initiate any new messages. If the employee selects an existing message (e.g., an outbound message), the user interface manager 122 displays the selected message plus any available actions. The user interface manager 122 displays the content of a selected outbound message by analyzing a data model 232 to determine how to display each field. For example, the user interface manager 122 can analyze the data model 232 to determine if a number field is formatted as a number with or without decimal places, and so on. The user interface manager 122 determines the available actions for the particular outbound message by analyzing a current state transition model 230 and rules 118 associated with the trading partners associated with the message. For example, the user interface manager 122 determines that a “PO cancel” action is only available if the following rule is satisfied: “PO may only be cancelled within 3 days from when the PO is created”.

If the employee selects a new message to be initiated the user interface manager 122 displays a form soliciting new message fields from the employee. The user interface manager 122 determines, from the action selected by the user, the particular inbound message that needs to be created. The user interface manager 122 uses the rules dependency profile 236 to determine the fields that are required by the inbound message based on the rules references to message fields as indicated by the dependency profile 236.

For each field, the user interface manager 122 uses one or more access paths to determine how to find the field in the transaction history cache 114 and then goes through each step of the access path. A field's reference scheme is used to lookup the field in the cache. If the access path step can be found in the cache 114 then the user interface manager 122 uses the cached value. If the access path step is not in the cache 114 then the user interface manager 122 tries another access path if there is one. If there are not any access paths that can be fully resolved then the user interface manager 122 selects one of the access paths (e.g., the access path with the shortest unresolved path) and solicits the employee for the data needed to satisfy the next step in the path. The user interface manager 122 applies the established rules 118 to guide the employee in entering the data.

For example, the user interface manager 122 can specify data that is valid for the message being constructed according to the rules 118. In this embodiment, the user interface 124 only shows valid selections or grays out invalid choices (or uses another visual indication that a choice is invalid). The user interface 124 also provides feedback to a user if the user enters data that is not valid per the rules. Thus, the user interface manager 122 creates a user interface that solicits a user to enter only those fields and access paths needed for later processing, and only in a form that is consistent with the rules 118.

The following is an illustrative example of this process that utilizes the following three rules: (1) “each PO Change message must reference an existing PO that is confirmed”; (2) “each PO Change message must reference an existing PO Line Item that has not been shipped”; and (3) “a PO Change message may not increase a PO Line Item quantity by more than 100%”. In this example, a trading partner employee logs into a web portal and selects the option for “create PO Change message”. Because of the first rule (and the way the data model is configured, with PO Line Items contained inside POs), the user interface manager 122 first displays a list of existing POs that are in a “confirmed” state.

The employee selects one of the displayed POs, and the user interface manager 122 then shows the PO Line Items that are part of that PO and that are not shipped. The employee then selects one of the displayed PO Line Items, and the user interface manager 122, via the user interface 124, shows the details of the selected PO Line Item (such as the quantity). In this example, the employee changes the quantity. If this change violates the third rule, the user interface manager 122 rejects the change with an error message. Otherwise, the user interface manager 122 constructs the inbound message based on the input from the employee. Therefore, the user interface manager 122 is responsive to the data model 232 and the rules 118 established with the individual trading partner. While these rules apply to this trading partner, the same or different rules can apply to another trading partner. If different rules apply, a different set of selections are offered and edits applied by the user interface manager 122.

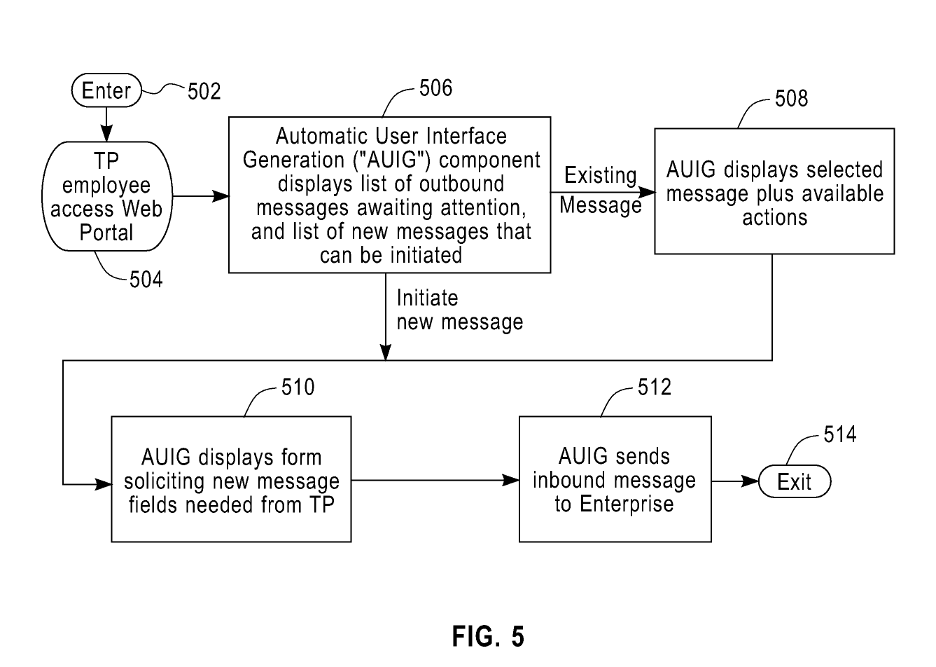

FIG. 5 is a flow diagram illustrating a process for automatically generating user interfaces according to one embodiment of the present invention. The flow diagram of FIG. 5 begins at step 502 and flows directly to step 504. At step 504, an employee of a trading partner that does not have automated system support accesses the web portal 226. The user interface manager 122, at step 506, automatically generates a list 231 of outbound messages that are awaiting attention. In this embodiment, the user interface manager 122 also displays a list of new messages that can be initiated. If the employee selects an existing message (e.g., an outbound message), the user interface manager 122, at step 508, displays the selected message plus any available actions via the automatically generated user interface 124. The control then flows to step 510.

If the employee instead selects a new message to be initiated or after the employee responds to an existing message, the user interface manager 122, at step 510, displays a form soliciting new message fields from the employee. The user interface manager 122 determines from the action selected by the user the particular inbound message that needs to be created. The user interface manager 122, at step 512, then sends the inbound message to the enterprise system 110. The control flow then exits at step 514.

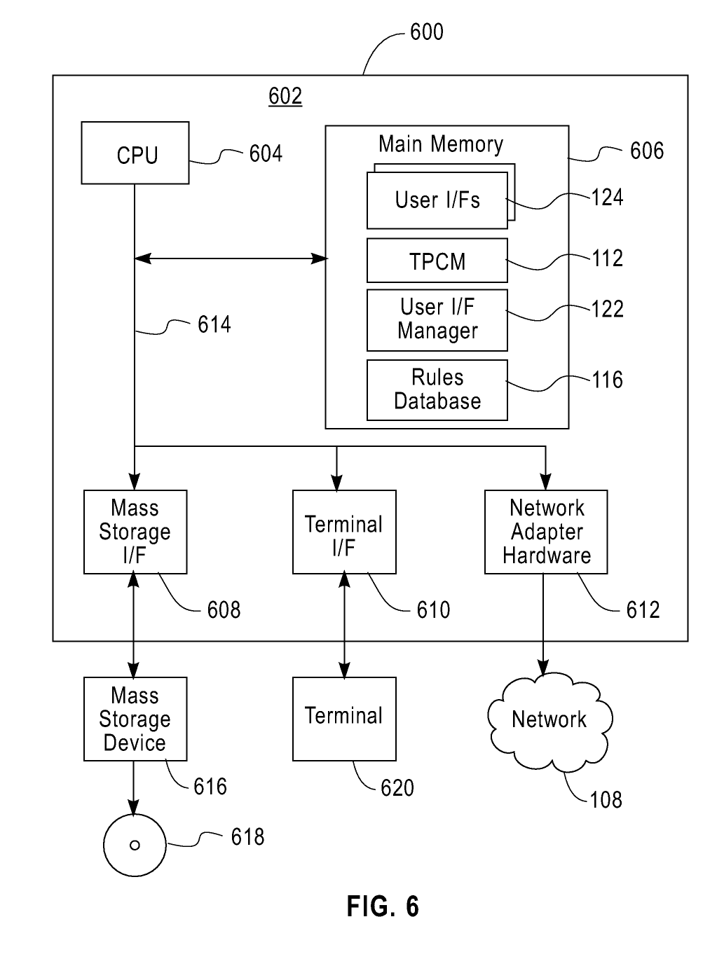

FIG. 6 is a block diagram illustrating an information processing system that is useful for implementing embodiments of the present invention. The information processing system 600 is a suitably configured processing system adapted to implement an embodiment of the present invention. Any suitably configured processing system is able to be used, such as a personal computer, workstation, or the like.

This exemplary information processing system 600 includes a computer 602. The computer 602 has a processor 604 that is connected to a main memory 606, a mass storage interface 608, a terminal interface 610, and network adapter hardware 612. A system bus 614 interconnects these system components. The mass storage interface 608 is used to connect mass storage devices, such as data storage device (or mass storage device) 616, to the information processing system 600. One specific type of data storage device (or mass storage device) is a disk drive that can store data to and read data from a computer readable medium, such as an optical disk 618 or a magnetic disk.

The main memory 606, which can be volatile and/or non-volatile memory, in this embodiment, includes, among other things, the TPCM 112, user interface manager 122, user interfaces 124, rule database 116, and rules 118. The rule database 116 and the rules 118 can also reside on one or more mass storage device, such as mass storage device 616 comprising non-volatile memory.

Although illustrated as concurrently resident in the main memory 606, such components are not required to be completely resident in the main memory 606 at all times or even at the same time. In this embodiment, the information processing system 600 utilizes conventional virtual addressing mechanisms to allow programs to behave as if they have access to a large, single storage entity, referred to as computer system memory, instead of access to multiple, smaller storage entities such as the main memory 606 and data storage device 616. The term “computer system memory” thus generically refers to the entire virtual memory of the information processing system 600.

Although only one CPU 604 is illustrated for computer 602, computer systems with multiple CPUs can be used equally effectively. This embodiment of the present invention further incorporates interfaces that each includes separate, fully programmed microprocessors that are used to off-load processing from the CPU 604. Terminal interface 610 is used to directly connect one or more terminals 620 to computer 602 to provide a user interface to the computer 602. These terminals 620, which are able to be non-intelligent or fully programmable workstations, are used to allow system administrators and users to communicate with the information processing system 600. The terminal 620 is also able to be a user interface and peripheral devices that are connected to computer 602 and controlled by terminal interface hardware included in the terminal interface 610 that includes video adapters and interfaces for keyboards, pointing devices, and the like.

An operating system is included in the main memory, and is preferably a suitable multitasking operating system. However, further embodiments of the present invention use any other suitable operating system. Some embodiments of the present invention utilize an architecture, such as an object oriented framework mechanism, that allows instructions of the components of operating system to be executed on any processor located within the information processing system 600. The network adapter hardware 612 is used to provide an interface to a network 108. Embodiments of the present invention are able to be adapted to work with any data communications connections including present day analog and/or digital techniques, or a future networking mechanism.

Although this exemplary embodiment of the present invention is described in the context of a fully functional computer system, further embodiments are capable of being distributed as a program product via a tangible computer readable medium (such as a CD, DVD, diskette, flash memory device, or other form of recordable media), or via any type of electronic transmission mechanism.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

What is claimed is:

1. A method for automatically generating user interfaces in a trading partner collaboration environment, the method comprising the steps of:
retrieving at least one trading partner business rule that defines at least one trading partner agreement between at least two trading partners;
automatically generating a user interface based on the at least one trading partner business rule and the at least one trading partner agreement, the user interface enabling a user to at least one of respond to an outbound message and create an inbound message; and
displaying, via the user interface, a set of inbound messages available for creation to the user, the set of inbound messages that are displayed being based on the at least one trading partner business rule and the at least one trading partner agreement.

2. The method of claim 1, wherein the automatically generating step comprises:
monitoring a plurality of state transition models associated with the at least one trading partner agreement; and
automatically generating the user interface based on a current state of at least one of the state transition models.

3. The method of claim 2, wherein in the displaying step, the set of inbound messages is based on the current state of the at least one state transition model.

4. The method of claim 2, further comprising the steps of:
displaying a set of outbound messages that are available for selection by the user;
receiving from the user a selection of at least one of the outbound messages from the set of outbound messages; and
displaying to the user at least one available action associated with the at least one outbound message based on the current state of the at least one state transition model and at least one trading partner business rule.

5. The method of claim 1, further comprising the steps of:
receiving a selection from the user of at least one inbound message from the set of inbound messages; and
determining at least one message content dependency associated with at least one trading partner business rule that is associated with the at least one inbound message, the message content dependency indicating message content from a cached message that is required by the at least one inbound message based on the at least one trading partner business rule.

6. The method of claim 5, wherein the message content required by the at least one inbound message resides in a transaction history cache, and
the method further comprises the step of generating the at least one inbound message based on the message content residing in the transaction history cache.

7. The method of claim 6, further comprising the step of accessing the transaction history cache using a partially ordered set of queries.

8. The method of claim 5, wherein the message content required by the at least one inbound message does not reside in a transaction history cache, and
the method further comprises the steps of:
prompting, via the user interface, the user to enter the message content that is required by the at least one inbound message; and
receiving, from the user via the user interface, the message content that is required by the at least one inbound message.

9. The method of claim 8, further comprising the step of generating the at least one inbound message based on the message content that is received from the user.

10. The method of claim 8, further comprising the steps of:
determining that at least a portion of the message content received from the user violates at least one trading partner business rule; and
notifying the user via the user interface that the message content is invalid.

11. The method of claim 1, further comprising the step of displaying a set of outbound messages that are available for selection by the user.

12. An information processing system for automatically generating user interfaces in a trading partner collaboration environment, the information processing system comprising:
a memory;
a processor communicatively coupled to the memory; and
a trading partner collaboration agreement manager (TPCM) communicatively coupled to the memory and the processor, the TPCM being adapted to:
retrieve at least one trading partner business rule that defines at least one trading partner agreement between at least two trading partners;
automatically generate a user interface based on the at least one trading partner business rule and the at least one trading partner agreement, the user interface enabling a user to at least one of respond to an outbound message and create an inbound message; and
display, via the user interface, a set of inbound messages available for creation to the user, the set of inbound messages that are displayed being based on the at least one trading partner business rule and the at least one trading partner agreement.

13. The information processing system of claim 12, wherein the TPCM is adapted to automatically generate the user interface by:
monitoring a plurality of state transition models associated with the at least one trading partner agreement; and
automatically generating the user interface based on a current state of at least one of the state transition models.

14. The information processing system of claim 12, wherein the TPCM is further adapted to:
receive from the user a selection of at least one inbound message from the set of inbound messages; and
determine at least one message content dependency associated with at least one trading partner business rule that is associated with the at least one inbound message, the message content dependency indicating message content from a cached message that is required by the at least one inbound message based on the at least one trading partner business rule.

15. The information processing system of claim 12,
wherein the message content required by the at least one inbound message does not reside in a transaction history cache, and
the TPCM is further to adapted to:
prompt, via the user interface, the user to enter the message content that is required by the at least one inbound message; and
receive, from the user via the user interface, the message content that is required by the at least one inbound message.

16. The information processing system of claim 13, wherein the TPCM is further to adapted to:
display a set of outbound messages that are available for selection by the user;
receive from the user a selection of at least one outbound message from the set of outbound messages; and
display to the user at least one available action associated with the at least one outbound message based on the current state of the at least one state transition model and at least one trading partner business rule.

17. A computer program product for automatically generating user interfaces in a trading partner collaboration environment, the computer program product comprising instructions for:
retrieving at least one trading partner business rule that defines at least one trading partner agreement between at least two trading partners;
automatically generating a user interface based on the at least one trading partner business rule and the at least one trading partner agreement, the user interface enabling a user to at least one of respond to an outbound message and create an inbound message; and
displaying, via the user interface, a set of inbound messages available for creation to the user, the set of inbound messages that are displayed being based on the at least one trading partner business rule and the at least one trading partner agreement.

18. The computer program product of claim 17, wherein the instructions for automatically generating include instructions for:
monitoring a plurality of state transition models associated with the at least one trading partner agreement; and
automatically generating the user interface based on a current state of at least one of the state transition models.

19. The computer program product of claim 17, wherein the computer program product further comprises instructions for:
receiving from the user a selection of at least one inbound message from the set of inbound messages; and
determining at least one message content dependency associated with at least one trading partner business rule that is associated with the at least one inbound message, the message content dependency indicating message content from a cached message that is required by the at least one inbound message based on the at least one trading partner business rule.

20. The computer program product of claim 18, wherein the computer program product further includes instructions for:
displaying a set of outbound messages that are available for selection by the user.
receiving from the user a selection of at least one outbound message from the set of outbound messages; and
displaying to the user at least one available action associated with the at least one outbound message based on the current state of the at least one state transition model and at least one trading partner business rule.
